(19) United States
(12) Patent Application Publication
(10) Pub. No.: US 2005/0144642 A1
(43) Pub. Date: Jun. 30, 2005

(54) Systems and methods for communicating with customers in the hospitality industry

(76) Inventor: Craig Ratterman, Brentwood, TN (US)

Correspondence Address: MICHAEL D. BEDNAREK;SHAW PITTMAN LLP, 1650 TYSONS BOULEVARD, MCLEAN, VA, 22102, US

(21) Appl. No.: 11/016,730

(22) Filed: Dec. 21, 2004

Related U.S. Application Data
(60) Provisional application No. 60/532,178, filed on Dec. 24, 2003.

(51) Int. Cl. H04N 7/173; H04N 7/18; G06F 13/00; H04N 5/445; G06F 3/00

(52) U.S. Cl. 725/78; 725/74; 725/86; 725/60

(57) ABSTRACT

An interactive customer computer system for a hospitality facility includes a Web client, a property management system server, an event management server, a facility services server, an advertisement server, a security server, and a Web server. A customer accesses the customer computer system using the Web client. The Web server manages communication between the Web client and the property management system server, the event management server, the facility services server, advertisement server, and the security server. A hospitality facility administrator uses the customer computer system to send a message to a group of customers and to target advertising to customers based on information in the customer database of the property management system server. A customer uses the customer computer system to send a message to another customer and to obtain directions from a customer room to a location within the hospitality facility.

### CROSS-REFERENCE TO RELATED APPLICATION

This application claims the benefit of U.S. Provisional Patent Application Ser. No. 60/532,178 filed Dec. 24, 2003, which is herein incorporated by reference in its entirety.

### BACKGROUND OF THE INVENTION

1. Field of the Invention

Embodiments of the present invention relate to systems and methods for communicating with and among customers in the hospitality industry. More particularly, embodiments of the present invention relate to systems and methods for interactively communicating between the hospitality facility and the customer, between the customer and endpoints outside of the hospitality facility, and between customers within the hospitality facility.

2. Background Information

Communication with customers in the hospitality industry takes a number of different forms. These forms include communication between the hospitality facility and the customer, between the customer and endpoints outside of the hospitality facility, and between customers within the hospitality facility. Traditionally, this communication has been accomplished using the telephone in a customer's room. A hotel guest calling for room service on the telephone is an example of communication between the hospitality facility and the customer. A hotel guest finding the telephone number of a local restaurant in the telephone book and calling the restaurant for reservations is an example of communication between the customer and endpoints outside of the hospitality facility. A hotel guest calling another hotel guest using a room number is an example of communication between customers within the hospitality facility.

More advanced technology has allowed additional methods of communication that are used by customers of a hospitality facility. A hotel can communicate information about its services to a guest by broadcasting this information to a channel on the television in the guest's room. A hotel guest can communicate a planned checkout time to the hotel by using an interactive feature of the television in their room. A hotel guest can connect with endpoints outside of the hospitality facility using an Internet connection provided in their room. A member of a convention can leave a message for another member of the convention at a computer kiosk located on the convention floor.

These advanced technologies have increased the overall communication capabilities of a customer of a hospitality facility. However, these advanced technologies have also increased the complexity of the customer's communication experience. The customer is forced to use a number of different devices and interfaces to perform different communication tasks. For example, a customer may use the telephone to schedule room service, use a personal computer connected to the Internet to find local directions to a business meeting, use a kiosk on the convention floor to leave a message for a colleague, and use the television to schedule the time of checkout.

### BRIEF SUMMARY OF THE INVENTION

One embodiment of the present invention is an interactive customer computer system for a hospitality facility. The customer computer system includes a Web client, a property management system server, an event management server, a facility services server, and a Web server. The Web client presents information to and accepts requests from the customer. The property management system server includes a customer database for the hospitality facility. The event management server provides event scheduling information to the customer. The facility services server provides the customer with the ability to request a hospitality service and to review information on the hospitality service requested. The Web server connects the Web client, the property management system server, the event management server, and the facility services server. The Web server also associates the customer with a customer record from the customer database of the property management system server. The Web server makes this association by matching data accepted from a request by the customer with a data element of the customer record.

Another embodiment of the present invention is a method for sending a group message from a hospitality facility administrator to a group of associated customers of a hospitality facility using a Web server of a customer computer system of the hospitality facility. A group messaging Web page is displayed to a hospitality facility administrator. A message containing a code identifying a group of associated customers is received from the hospitality facility administrator. A customer database of a property management system of the hospitality facility is queried for a list of customers whose records include the code. The message is sent to the list of customers.

Another embodiment of the present invention is a method for sending a message from a first customer of a hospitality facility to a second customer of the hospitality facility using a Web server of a customer computer system of the hospitality facility. A customer search Web page is displayed to a first customer. An identifier of a second customer is received from the first customer. A customer database of a property management system of the hospitality facility is queried for a list of customers whose records include the identifier. The list is displayed to the first customer. A selection from the list of customers is received from the first customer. The selection from the list of customers is the second customer. A messaging Web page addressed to the second customer is displayed to the first customer. A message is received from the first customer. The message is sent to the second customer.

Another embodiment of the present invention is a method for targeting at least one banner advertisement to a group of associated customers of a hospitality facility using a Web server of a customer computer system of the hospitality facility. An advertisement campaign is received from an advertisement server. The advertisement campaign includes at least one banner advertisement and a code identifying a group of associated customers. A customer database of a property management system of the hospitality facility is queried for a list of customers whose records include the code. At least one banner of the campaign is displayed on a Web page sent to a customer on the list of customers.

Another embodiment of the present invention is a method for displaying directions from a customer room to a location within a hospitality facility to a customer using a Web server of a customer computer system of the hospitality facility. A map service Web page is displayed to a customer on a Web client. A map type for the location from the map service Web page and a Web client identifier of the Web client are received from the customer. A database of the Web server is queried for a room corresponding to the Web client identifier. A map depicting a route from the room to a nearest elevator and from the nearest elevator to the location is displayed to the customer on the Web client.

### BRIEF DESCRIPTION OF THE DRAWINGS

FIG. 1 is a schematic diagram showing an exemplary interactive customer computer system for a hospitality facility, in accordance with an embodiment of the present invention.

FIG. 2 is a flowchart showing a method for sending a group message from a hospitality facility administrator to a group of associated customers of a hospitality facility using a Web server of a customer computer system of the hospitality, in accordance with an embodiment of the present invention.

FIG. 3 is an exemplary group messaging Web page displayed to a hospitality administrator by a Web server of a customer computer system of a hospitality facility, in accordance with an embodiment of the present invention.

FIG. 4 is a flowchart showing a method for sending a message from a first customer of a hospitality facility to a second customer of the hospitality facility using a Web server of a customer computer system of the hospitality facility, in accordance with an embodiment of the present invention.

FIG. 5 is an exemplary customer search Web page displayed to a customer by a Web server of a customer computer system of a hospitality facility, in accordance with an embodiment of the present invention.

FIG. 6 is an exemplary customer-to-customer messaging Web page displayed to a customer by a Web server of a customer computer system of a hospitality facility, in accordance with an embodiment of the present invention.

FIG. 7 is a flowchart showing a method for targeting at least one banner advertisement to a group of associated customers of a hospitality facility using a Web server of a customer computer system of the hospitality facility, in accordance with an embodiment of the present invention.

FIG. 8 is an exemplary advertisement campaign creation Web page used by an advertisement campaign administrator to specify a Web page location identifier, in accordance with an embodiment of the present invention.

FIG. 9 is a flowchart showing a method for displaying directions from a customer room to a location within a hospitality facility to a customer using a Web server of a customer computer system of the hospitality facility, in accordance with an embodiment of the present invention.

FIG. 10 is an exemplary Web page displaying directions from a customer room to a location within a hospitality facility, in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

One embodiment of the present invention facilitates communication among group participants (e.g., conference participants, convention participants, or tour group participants) and allows for the collection, analysis, and dissemination of information in the context of the hospitality industry.

“Participants” is used herein to refer to individuals who are participating in a group activity involving the hospitality and/or travel industry. Most commonly, participants are attending a conference, attending a convention, or participating in a travel group. A conference, convention, or travel group can be characterized by a collection of unique participants assembled for a common purpose for a set period of time (e.g., the duration of the conference, conference, or tour) and using an environment that hosts multiple and various participant groups on a regular basis (e.g., a conference hotel or resort cruise ship).

In this context, it is useful to be able to associate guests/participants with a group/sub-group and particular meeting, and maintain historical record information regarding the participant separate from group. As will be appreciated by those skilled in the art, the systems and methods of the present invention allow the operator of a conference, resort, or similar facility to treat participants as a guest, a meeting or tour participant, an attendee, and/or a sub-group member.

Another embodiment of the present invention, is a network system that includes a plurality of thin clients located in guest rooms. These thin clients (e.g., keyboard/monitor combinations) are accessible from a central server separately and/or group wise by creating ad hoc groups. In a preferred implementation, the central server coordinates communication among the networked computers (thin clients, central server, and switches). Preferably, the central server and guest room clients are located on a private network and the central server is also in communication with an external network (i.e., the Internet, or Global Information Network) to allow communication via such an external network. Alternatively, some or all of the clients could be linked through an external network such as the Internet.

From the vantage point of a meeting planner, for example, the systems and methods in accordance with the present invention allow the planner to “push” relevant information to participants as a group, as well as to sub-groups of participants.

The system allows various associations of participants to groups, sub-groups, event attendees, and particular rooms, all of which are preferably stored in a searchable database.

From the vantage point of the guest, the present invention provides various advantages, including touch of a button connectivity with the hotel to, for example:
Make reservations at restaurants;
Place orders for in room dining;
Make a spa appointment;
Request bell service;
Request housekeeping;
Access business center services;
Access in-room internet access;
Access a complete hotel mapping system to anywhere within hotel property; and
Obtain information about and directions to area attractions.

In the context of meetings, guest participants can use the system to access a group agenda, distribute conference materials, e-mail among other participants, take a virtual tour of a trade show floor, and set appointments with vendors.

As individual guests interact with the system, selections and preferences are preferably recorded and stored in records associated with that guest. The collection and storage of participant associations and preferences provides important information that can be understood and leveraged through analysis of information stored in the database. For example, the system could be used to determine which guests have not made arrangements for dinner and suggest a restaurant according to preferences, or even arrange dinner meetings among persons attending the same meeting.

Another embodiment of the present invention is directed to an in-room interactive communication system that provides hotel guests with improved touch-of-a-button connectivity. By accessing the appropriate portions of the system, hotel guests can, for example, make reservations at any of the facility's restaurants, place an order for in-room dining, or make appointments at or reservations for various activities.

The present invention provides the opportunity for a guest to obtain virtually all necessary hotel information via the interactive communication system, without having to resort to cumbersome guest directories or even calling the front desk or concierge. Virtually all hotel services are accessible via the in-room interactive communication system. For example, house keeping and bell service requests can be made via an in-room computer, without having to dial a front desk of the hotel.

In addition to hotel services, the in-room interactive communication system, according to the present invention, preferably provides Internet World Wide Web access so that hotel guests can stay connected with their home towns and/or conduct any other Internet-type business. For example, hotel guest, via the Internet, can make additional travel arrangements, as necessary, through their preferred on-line travel provider.

In addition, the present invention provides a unique facility by which hotel guests, from their respective rooms, can receive “personalized” directions from the guest's room to a particular destination within the hotel's facilities. The present invention preferably provides a detailed map via the in-room interactive communication system showing routing information along with “landmarks” to facilitate the trip from the guest's room to the particular venue that the guest is interested in locating.

Still another feature of the present invention is the ability for the in-room interactive communication system to provide information, not only with respect to the facilities of the hotel itself, but also about activities and attractions beyond or outside the hotel, including shopping, restaurants, and entertainment.

An important aspect of the present invention is the ability to provide targeted information to hotel guests. In many instances, hotel guests are participating in and/or attending meeting and/or conventions. The in-room interactive communication system of the present invention allows each guest to access information that is specifically related to the meeting or convention in which the guest is participating. The guest is able to view meeting agendas, as well as receive program updates and meeting-related messages via email. In addition, each guest can take a virtual tour of, for example, a trade show floor and, via the virtual tour, set up appointments with vendors directly through the interactive communication system.

Another feature of the present invention is the ability of multiple hotels participating in a single convention or event to use the system. In this embodiment, the interactive communication system is connected to a property management system of each hotel participating in the convention or event. The interactive communication system serves as the central repository for information relating to the convention or event.

Thus, as will be appreciated by those skilled in the art, the present invention provides personalized service to each guest staying at a hotel. Instead of conventional, generic, directory boards that may be placed in common areas of a hotel and that may provide information regarding all events taking place at the hotel, the present invention provides specifically-targeted information that each guest will likely have interest in. In addition, meeting planners/organizers can “push” information to entire groups of attendees of meetings or, instead, send information to predetermined sub-groups of the groups of attendees. For example, there may be separate side meetings planned for eastern and western divisions of a sales force that is attending a common meeting. In such a case, the in-room interactive communication system can send emails (or other message types) and provide program information to those guests respectively associated with the eastern and western divisions. Consequently, there is less confusion among the participants, thereby smoothing the overall operations of a large conference.

In addition to the foregoing in-room interactive communication system, the present invention also provides personalized information to hotel guest even when they may not be in their own rooms. For example, a kiosk may be placed in common areas of a hotel and by appropriately signing into the kiosk, the guest will receive the same type of personalized information that would normally be available only in his room. In one possible embodiment, a guest can use his electronic key card, which is normally used to open hotel room doors, to identify himself to the computing system associated with the kiosk. As will be appreciated by those skilled in the art, the personalized information is preferably “keyed” to a particular guest room in the hotel. Thus, by “swiping” a room key at a kiosk, the hotel guest can be identified via his room, and be provided the personalized information being sought.

In accordance with another embodiment of the present invention, personalized information can be pushed to a hotel guest via a wireless connection. In this case, a guest's own personal digital assistant (PDA), or one issued by the hotel, can be used to wirelessly receive personalized information sent to the guest. Through this wireless connection, the guest may also, for example, request hotel services, or receive personalized map directions. In a similar fashion, a guest's laptop computer could be configured to receive the same wireless communications that are directed to the PDAs discussed above. Guests may feel more comfortable using their own equipment, as compared to using something issued or supplied by the hotel.

The wireless embodiment of the present invention can also be expanded to pre- and post-registration periods at the hotel. In the same fashion that map/directions might be provided to a hotel guest while staying at the hotel, this same room-specific information can be passed to a hotel guest, assuming, for example, that a room has been assigned to him, even before that guest arrives at the hotel. Similarly, as a post-check out service, guests may be able to request and be provided their folios (hotel statements) well after leaving the hotel, and the hotel may even elect to administer surveys to former guests of the hotel.

Based on the interactive nature of the present invention, the present invention can collect information about hotel guests' stays so that the overall experience of all guests can be improved. Moreover, due to the personalized nature of the systems described herein, the present invention can also be used to enhance a subsequent hotel experience for any particular guest. For example, if a guest has asked for extra towels or pillows during a previous stay, the present invention is capable of notifying the appropriate personnel of these previous requests, in an effort to anticipate and satisfy such requests before that guest again checks into the hotel for a subsequent stay. The in-room interactive communication system can then be used to notify the guest upon his arrival in his room that the amenities desired have already been accounted for. Alternatively, or in addition, the guest can be notified during a pre-registration period that his preferences have been accounted for.

Another feature of the present invention tracks meeting schedules and determines whether participants may have periods of downtime, during which no particular activities are planned. Using this information, the interactive in-room communication system can be used to offer specific activities (e.g., suggest making a reservation at a hotel restaurant, or offer an outside excursion) to enhance a guest's experience, and to direct the guest to particular events/activities/locations that the hotel might consider to be most profitable, and, importantly, will cause the guest to even further enjoy his stay.

In one embodiment, the present invention comprises a collection of servers, switches, in-room terminals/computers, and connections for computers at convention or meeting venues. These devices are interconnected to provide a networked system via which messages, information, and other content can be pushed to individual room terminals/computers and via which guests and meeting participants can request information and respond to messages.

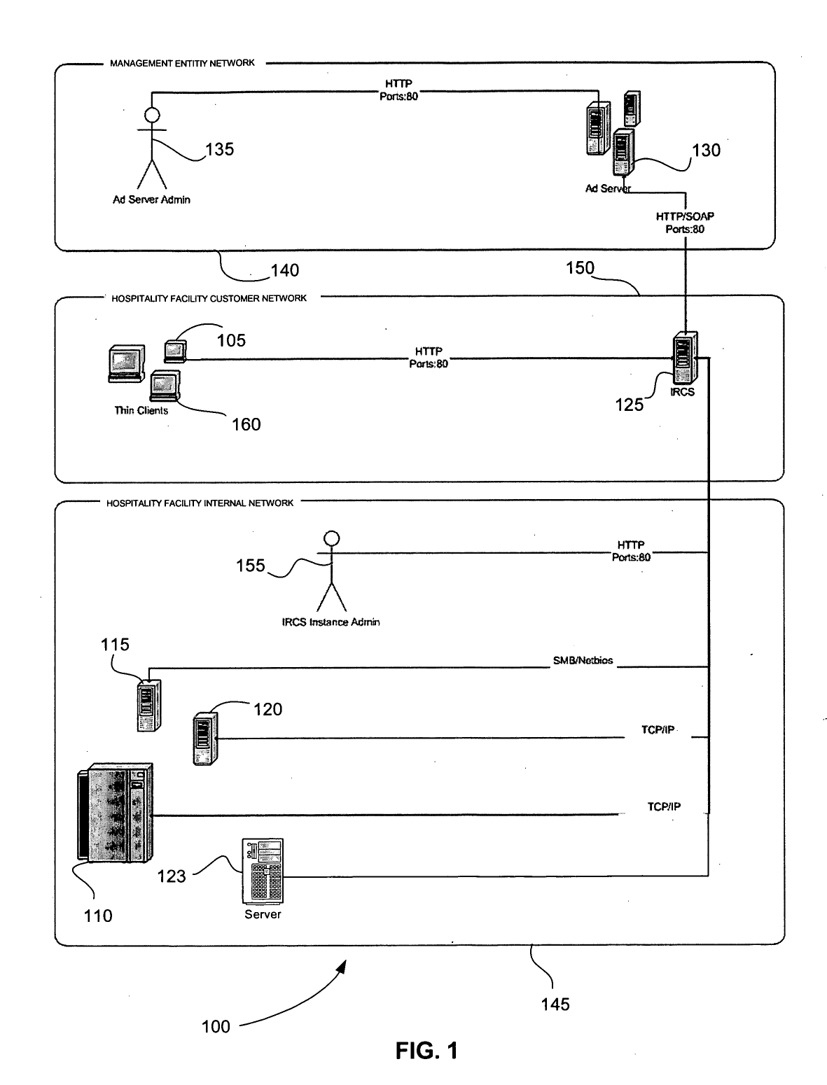

FIG. 1 is a schematic diagram showing an exemplary interactive customer computer system 100 for a hospitality facility in accordance with an embodiment of the present invention. Customer computer system 100 includes Web client 105, property management system server 110, event management server 115, facility services server 120, security server 123, and Web server 125. A customer accesses system 100 through Web client 105, which connects to Web Server 125. Property management system server 110, event management server 115, facility services server 120, and security server 123 provide information to the customer via Web server 125.

Web client 105 presents information to and accepts requests from the customer. Web client 105 is an in-room terminal or in-room computer, for example. Alternatively, Web client 105 is the customer's computer, the customer's personal digital assistant, the customer's cellular telephone, or a computer kiosk within the hospitality facility, for example. The computer kiosk is accessed using an electronic room key card, for example. The customer is a hotel guest, a motel guest, a resort guest, or a convention participant, for example. Actions performed by the customer using Web Client 105 can include but are not limited to reviewing account information, checking into the hospitality facility, checking out of the hospitality facility, requesting a hospitality facility service, reviewing the hospitality facility service, accessing a mapping system of the hospitality facility, accessing information about local attractions, reviewing messages, and reviewing a convention schedule. A hospitality facility service can include but is not limited to room service, bell service, valet service, laundry service, housekeeping service, a spa appointment, and a business center appointment.

Property management system server 110 includes a customer database for the hospitality facility. Property management system server 110 is used to assign rooms to customers, for example. The customer database of property management system server 110 is used to store information about customers including their home addresses, any affiliations they might have, any groups they might be participating in, and the type of rate they are paying for their stay, for example. The hospitality facility is a hotel, a motel, a resort, or a convention center, for example. In an embodiment of the customer computer system 100, information is sent to a customer from Web server 125 based on information stored in the customer database of property management system server 110.

Event management server 115 provides event scheduling information to the customer. An event is a specific function at a given time and date held for a group or subgroup within a property. An event is a convention, for example. Convention scheduling information includes the time and place of convention meetings and presentations, for example. In one embodiment of the present invention, meeting notes are made available to an event participant via the event management server 115. Meeting notes can include but are not limited to electronic versions of Microsoft PowerPoint™ and Microsoft Word™ files. Audio and video recordings of meetings are also downloadable from system 100 using event management server 115. Access to event management server 115 can be limited by group code or affiliation code.

Facility services server 120 provides the customer with the ability to request a hospitality service and to review information on the hospitality service requested. A hospitality facility service can include but is not limited to room service, bell service, valet service, laundry service, housekeeping service, a spa appointment, and a business center appointment. The customer can request room service by sending a request to facility services server 120 and can query the status of the room service by sending a query to facility services server 120, for example.

Security server 123 provides authentication and security services to the customer. Security server 123 monitors access to all locked rooms of a hospitality facility. Security server 123 electronically controls locks and provides authentication services for electronic key card access. Security server 123 is connected to a smart card and magnetic card based electronic locking system (not shown) such as TimeLox™ sold by the Assa Abloy Group, for example. In another embodiment of system 100, the key card can include radio frequency identifiers (RFIDs). Security server 123 allows a customer to determine if anyone has entered the customer's room recently. Such information allows the customer to determine if housekeeping has entered the room, or if a spouse has returned to the room, for example. Such information can be obtained from any Web client 105 outside of the room. Security server 123 allows authentication of electronic key cards. Security server 123 allows a customer to determine if their room door is open.

In one embodiment of the present invention, a customer can access security server 123 using system 100 to determine if the customer's room has been made. A customer accesses system 100 using a Web client 105 located outside of the customer's room. The customer can access the Web client 105 using the customer's key card. A hospitality facility housekeeping staff person also has a key card. Security server 123 records all of the key cards that access the customer's room. The customer accesses this information through Web client 105 and Web server 125 in order to determine if and when housekeeping has entered and left the customer's room.

In another embodiment of the present invention, a customer can access facility services server 120 to schedule a room cleaning and receive confirmation of that cleaning by accessing security server 123. A customer accesses facility services server 120 using Web client 105 to schedule a room cleaning. Web client 105 connects to facility services server 120 through Web server 125. Web client 105 can be in the customer's room or outside of the customer's room. The customer receives confirmation that a member of the housekeeping staff has entered the customer's room from security server 123. Security server 123 provides this information to Web server 125, and the customer accesses this information from Web client 105.

Web server 125 connects Web client 105, property management system server 110, event management server 115, facility services server 120, and security server 123. Web server 125 acts as the communication manager between Web client 105 and property management system server 110, event management server 115, facility services server 120, and security server 123. Web server 125 also associates the customer with a customer record from the customer database of property management system server 110. Web server 125 makes this association by matching data accepted from a request by the customer with a data element of the customer record. For example, if Web client 105 is an in-room terminal or computer, the room number of Web client 105 is known to Web server 125. Web server 125 then matches the room number of Web client 105 to the room number data element of the customer record obtained from the customer database of property management system server 110. Other data elements that allow Web server 125 to associate Web client 105 with a customer can include but are not limited to a customer name, a customer identification number, a customer password, a room number, an email address, and a code from an electronic key card. In another embodiment of the present invention, Web server 125 updates information in property management system server 110. This embodiment allows customers to make changes to their personal information using Web client 105. Further, updates to property management system server 110 trigger notification to hospitality facility staff. This notification can include but is not limited to emails and electronic messages.

Associating Web client 105 with a customer using Web server 125 allows a hospitality facility to target information sent to the customer. Another name for this targeting of information is personalization. A customer may ask the system for a weather report at their home address, for example. By associating the weather report request with a customer record of the customer database of property management system server 110, Web server 125 can present a weather report without having to request the home address.

Web server 125 further includes a database that includes information collected from property management system server 110, event management server 115, and facility services server 120. This database also enables Web server 125 to store additional information along with the information collected from property management system server 110, event management server 115, and facility services server 120. In one embodiment, the database of Web server 125 stores information on a hospitality service requested by a customer in a previous stay. This information on a hospitality service requested by a customer in a previous stay is then accessed by the hospitality facility staff whenever the customer returns to the hospitality facility. If, for example, a customer ordered a rollaway bed on a previous stay, a rollaway bed can be made available before the customer checks in and the customer can be asked at the time of check-in if she requires a rollaway bed again.

In another embodiment of customer computer system 100, advertisement server 130 is connected to Web server 125 and provides banner advertisements targeted to customers. Banner advertisements are advertisements placed on Web pages visible to customers. Banner advertisements are targeted based on information stored in the customer database of property management system server 110. The information stored in the customer database of property management system server 110 and used to target banner advertisements can include but is not limited to a guest room, a convention participant name, a group code, an affiliation code, a rate plan code, a hospitality facility location, and a convention. A group code is preferably a subset of the affiliation code. For example, an advertiser might want to target the northeast region salespeople of company XYZ. A hospitality facility can then send banner advertisements to all customers who have an affiliation code for company XYZ and a group code that represents the northeast region salespeople. Further, advertisement server 130 records banner advertisement impressions and clicks. Impressions are the number times a banner advertisement is shown to a customer. Clicks are the number of times a customer selects a banner advertisement. In addition to recording impressions and clicks, the entire customer record of the customer who receives the impression or performs the click is available to advertisement server 130. Advertisement server 130 is controlled by advertisement server administrator 135 through a Web client. An advertisement server administrator 135 groups banner advertisements into campaigns and selects groups of customers to which the campaigns are targeted.

In another embodiment of customer computer system 100, advertisement server 130, and advertisement server administrator 135 are connected to network 140 of a hospitality management entity that manages more than one hospitality facility. Advertisement server 130 is used to transmit advertisements to the multiple hospitality facilities. In this embodiment, property management system server 110, event management server 115, and facility services server 120 are connected to internal network 145 of a hospitality facility. Web client 105 and Web server 125 are connected to customer network 150 of the hospitality facility.

In another embodiment of the present invention, group messaging is performed via a group messaging Web client 155. Group messaging Web client 155 is connected to Web server 125 and is accessed by a hospitality facility administrator. A hospitality facility administrator can include but is not limited to a meeting planner, a hotel administrator, and a convention exhibitor. The hospitality facility administrator selects a group of customers that will receive the message based on data elements from the customer record of the customer database of property management system server 110. The data elements can include but are not limited to a group code, an affiliation code, and a rate plan code.

In another embodiment of the present invention, customer-to-customer messaging is performed by sending a message from Web client 105 to second Web client 160. Second Web client 160 presents information to and accepts information from a second customer. A first customer composes a message on Web server 125 using Web client 105. The first customer sends the message to the second customer. The second customer retrieves the message from Web server 125 and views the message on second Web client 160.

In another embodiment of the present invention, an Internet connection (not shown) is connected to Web server 125. The Internet connection provides communication between the customer and an endpoint outside of the hospitality facility. The Internet connection allows the customer to make an airline reservation change using an online reservation system, for example.

In another embodiment of the present invention, system 100 is connected to an enterprise property management system (not shown). The enterprise property management system contains information relating to one or more properties that do not have their own property management systems. These properties can include but are not limited to resorts, time share properties, or condominiums. Information provided by an enterprise property management system can include but is not limited to a guest name, a unit name, a complex name, a resort name, a geographical region, and a package type.

In another embodiment of the present invention, servers are provided for each department of a hospitality facility. A concierge server is provided in order to give customers interactive access to concierge services. Concierge services can include but are not limited to arranging dinner reservations or obtaining attractions tickets. A transportation server is provided in order to give customers interactive access to transportation services. Transportation services can include but are not limited to arranging limousine service, tour bus service, or airport shuttle service.

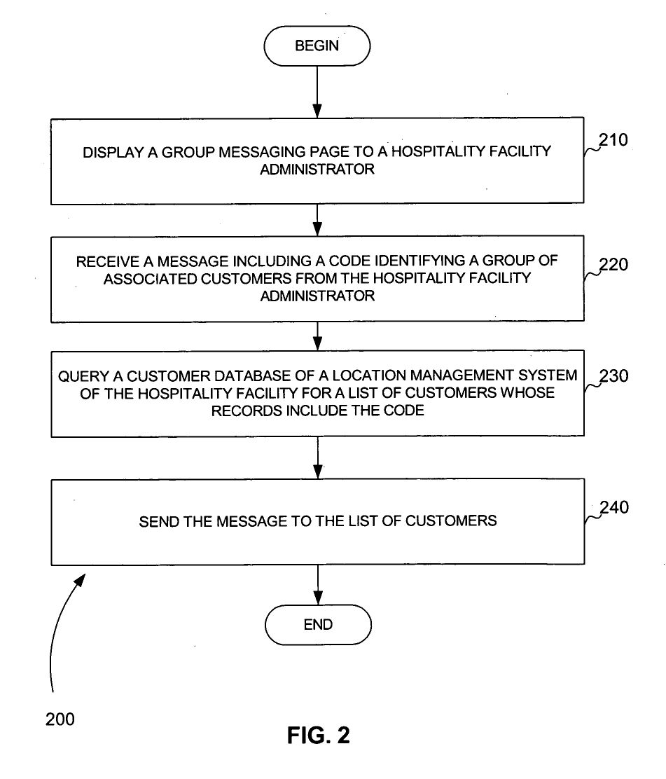

FIG. 2 is a flowchart showing a method 200 for sending a group message from a hospitality facility administrator to a group of associated customers of a hospitality facility using a Web server of a customer computer system of the hospitality, in accordance with an embodiment of the present invention.

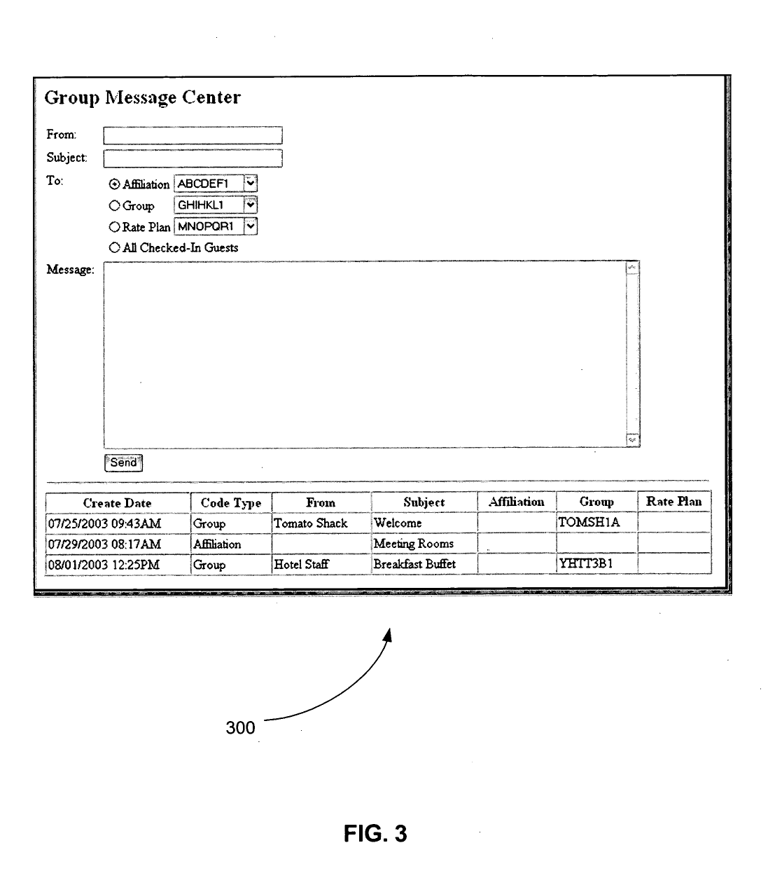

In step 210 of method 200, a group messaging Web page is displayed to a hospitality facility administrator. FIG. 3 is an exemplary group messaging Web page 300 displayed to a hospitality administrator by a Web server of a customer computer system of a hospitality facility, in accordance with an embodiment of the present invention.

In step 220 of FIG. 2, a message containing a code identifying a group of associated customers is received from the hospitality facility administrator. The code can include but is not limited to an affiliation code, a group code, a rate plan code, or a code for all checked-in customers of the hospitality facility.

In step 230, a customer database of a property management system of the hospitality facility is queried for a list of customers whose records include the code.

In step 240, the message is sent to the list of customers. The message is sent by placing the message in the mailbox on the Web server of each customer on the list, for example.

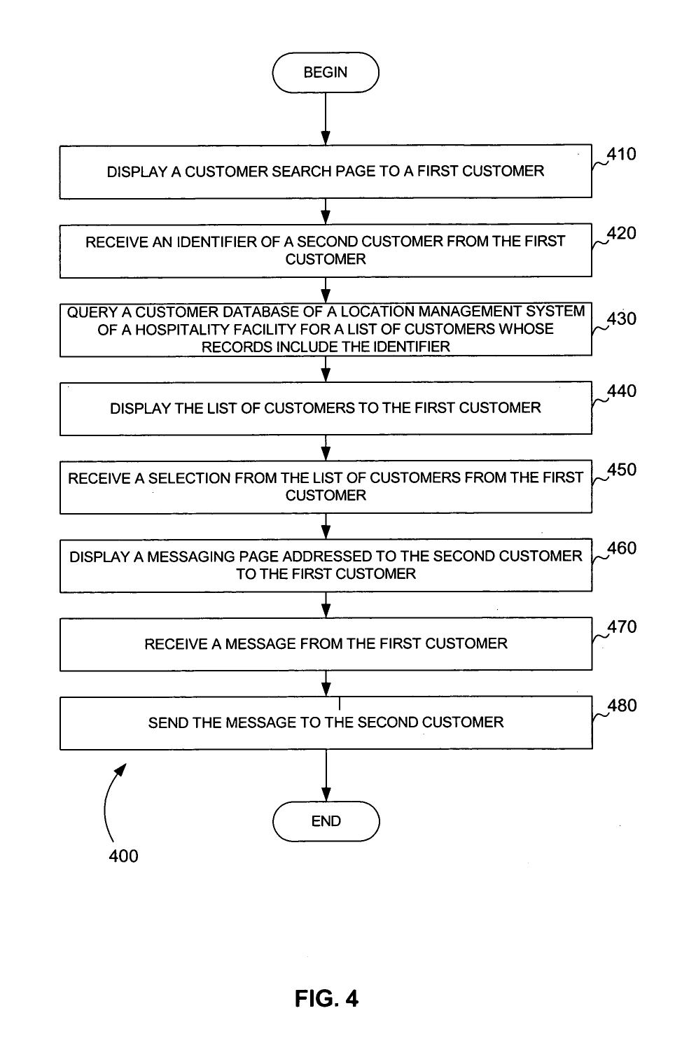

FIG. 4 is a flowchart showing a method 400 for sending a message from a first customer of a hospitality facility to a second customer of the hospitality facility using a Web server of a customer computer system of the hospitality facility, in accordance with an embodiment of the present invention.

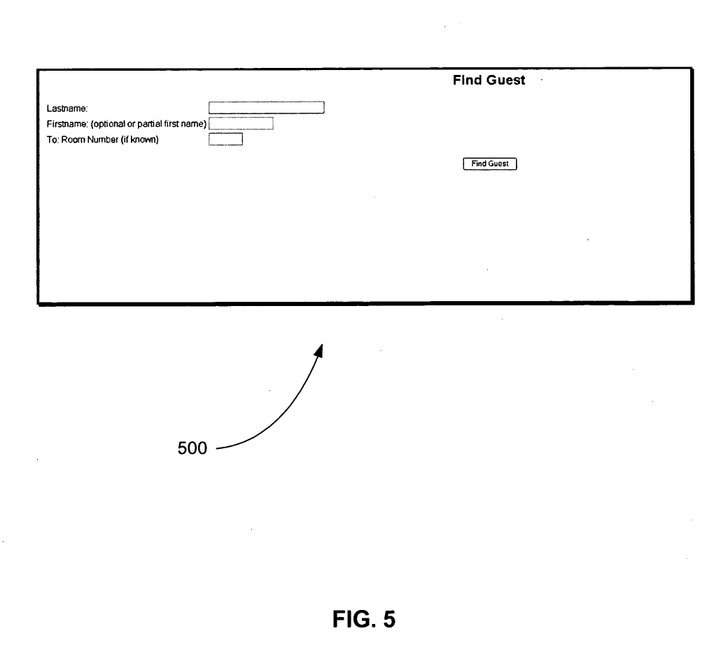

In step 410 of method 400, a customer search Web page is displayed to a first customer. FIG. 5 is an exemplary customer search Web page 500 displayed to a customer by a Web server of a customer computer system of a hospitality facility, in accordance with an embodiment of the present invention.

In step 420 of FIG. 4, an identifier of a second customer is received from the first customer. The identifier can include but is not limited to an entire last name, an entire last name and partial first name, or an entire last name and room number.

In step 430, a customer database of a property management system of the hospitality facility is queried for a list of customers whose records include the identifier of the second customer.

In step 440, the list of customers is displayed to the first customer.

In step 450, a selection from the list of customers is received from the first customer. The selection from the list of customers is the second customer.

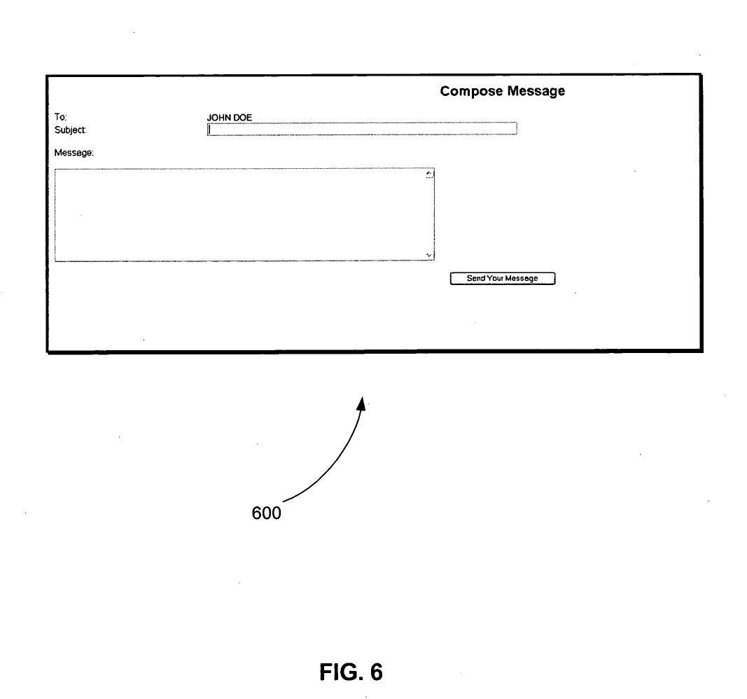

In step 460, a messaging Web page addressed to the second customer is displayed to the first customer. FIG. 6 is an exemplary customer-to-customer messaging Web page displayed to a customer by a Web server of a customer computer system of a hospitality facility, in accordance with an embodiment of the present invention.

In step 470 of FIG. 4, a message is received from the first customer.

In step 480, the message is sent to the second customer. The message is sent by placing the message in the mailbox on the Web server of the second customer, for example.

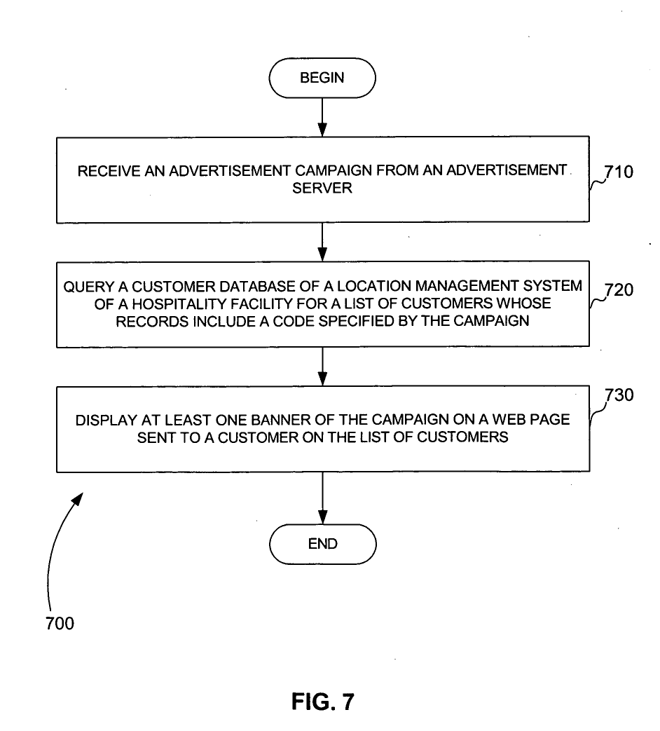

FIG. 7 is a flowchart showing a method 700 for targeting at least one banner advertisement to a group of associated customers of a hospitality facility using a Web server of a customer computer system of the hospitality facility, in accordance with an embodiment of the present invention.

In step 710 of methods 700, an advertisement campaign is received from an advertisement server. The advertisement campaign includes at least one banner advertisement and a code identifying a group of associated customers. The code can include but is not limited to an affiliation code, a group code, a rate plan code, of a code for all checked-in customers.

In step 720, a customer database of a property management system of the hospitality facility is queried for a list of customers whose records include the code.

In step 730, at least one banner of the campaign is displayed on a Web page sent to a customer on the list of customers.

In another embodiment of method 700, the Web server records if a customer clicks on a banner advertisement of an advertisement campaign. The total number of banner clicks performed by a customer and the room number of the customer are also reported to the advertisement server by the Web server.

In another embodiment of method 700, the advertisement campaign includes a hospitality facility location identifier. This identifier allows a hospitality facility management entity, which owns two or more hospitality facilities, to target advertisement campaigns to different locations or properties. When an advertisement campaign includes a hospitality facility location identifier, banner clicks reported to the advertisement server include the hospitality facility location identifier where the banner was clicked.

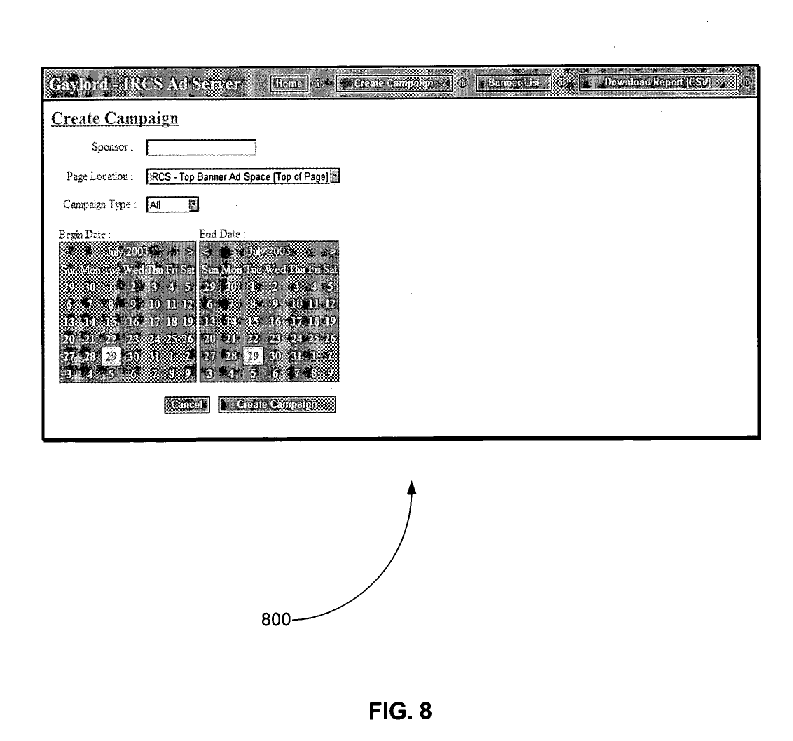

In another embodiment of method 700, the advertisement campaign includes a Web page location identifier. This identifier allows an advertisement server to specify the location on a Web page where a banner advertisement of the advertisement campaign should be placed. The Web page location identifier of an advertisement campaign is compared by the Web server to a Web page location identifier on a Web page sent to a customer. If the identifiers match, a banner advertisement is displayed. FIG. 8 is an exemplary advertisement campaign creation Web page 800 used by an advertisement campaign administrator to specify a Web page location identifier, in accordance with an embodiment of the present invention. Advertisement campaign creation Web page 800 also shows that an advertisement campaign administrator can specify a campaign sponsor and a begin and end date for the campaign.

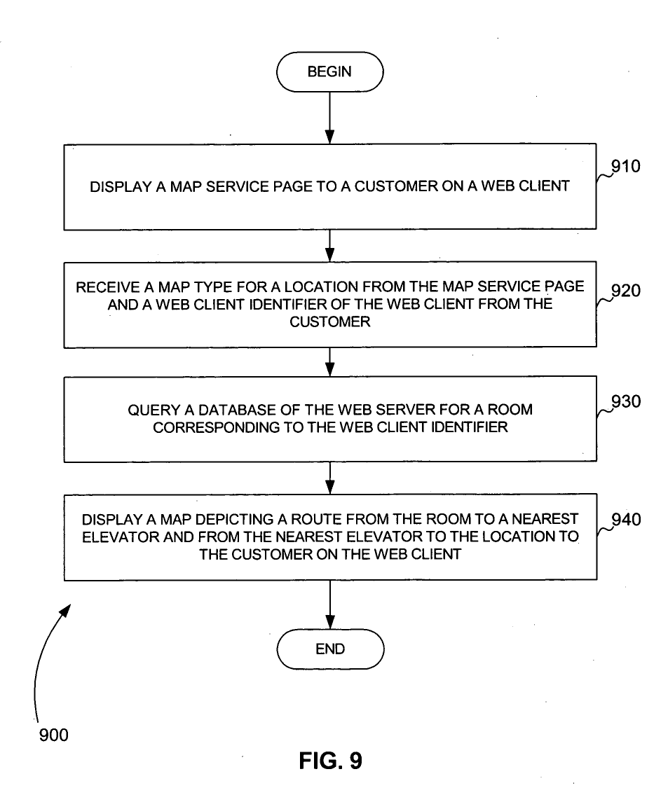

FIG. 9 is a flowchart showing a method 900 for displaying directions from a customer room to a location within a hospitality facility to a customer using a Web server of a customer computer system of the hospitality facility, in accordance with an embodiment of the present invention.

In step 910 of method 900, a map service Web page is displayed to a customer on a Web client.

In step 920, a map type for a location from the map service Web page and a Web client identifier of the Web client are received from the customer. The map type can include but is not limited to child care, meeting rooms, restaurants, stores, pools, or local transportation. The Web client identifier includes but is not limited to an Internet protocol address.

In step 930, a database of the Web server is queried for a room corresponding to the Web client identifier.

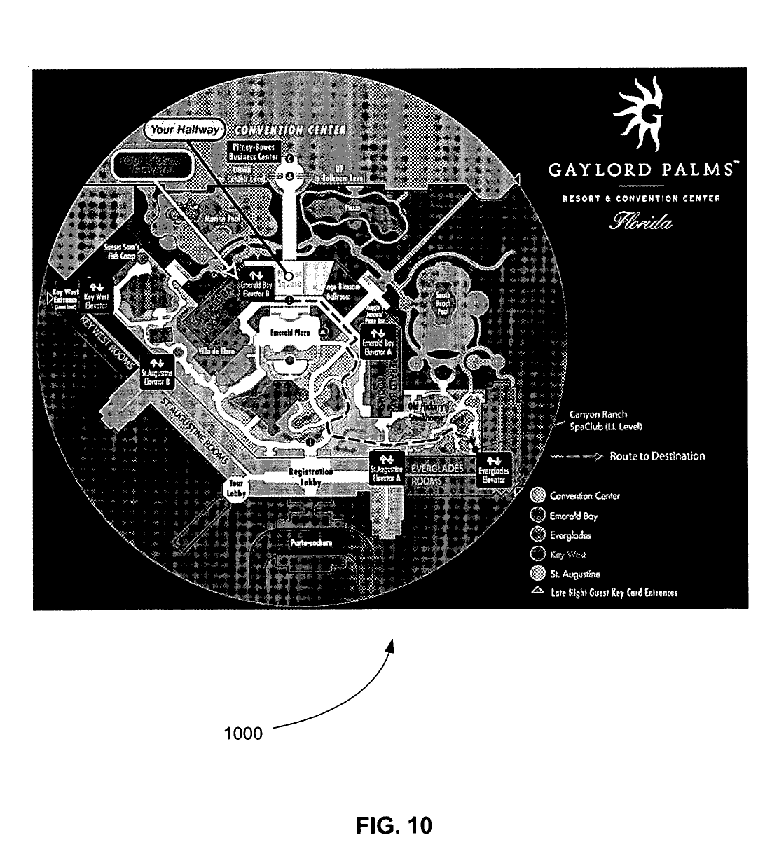

In step 940, a map depicting a route from the room to a nearest elevator and from the nearest elevator to the location is displayed to the customer on the Web client. FIG. 10 is an exemplary Web page 1000 displaying directions from a customer room to a location within a hospitality facility, in accordance with an embodiment of the present invention.

Embodiments of the present invention relate to data communications via one or more networks. The data communications can be carried by one or more communications channels of the one or more networks. A network can include wired communication links (e.g., coaxial cable, copper wires, optical fibers, a combination thereof, and so on), wireless communication links (e.g., satellite communication links, terrestrial wireless communication links, satellite-to-terrestrial communication links, a combination thereof, and so on), or a combination thereof. A communications link can include one or more communications channels, where a communications channel carries communications. For example, a communications link can include multiplexed communications channels, such as time division multiplexing (“TDM”) channels, frequency division multiplexing (“FDM”) channels, code division multiplexing (“CDM”) channels, wave division multiplexing (“WDM”) channels, a combination thereof, and so on.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Systems and methods in accordance with an embodiment of the present invention disclosed herein can advantageously provide a central location for communication between the hospitality facility and the customer, between the customer and endpoints outside of the hospitality facility, and between customers within the hospitality facility. Although the present invention has been described above principally in the context of a hotel, one of ordinary skill in the art would appreciate that the invention is applicable to other hospitality facilities such as motels, resorts, and convention centers. For this reason, notwithstanding the particular benefits of using the present invention for hotels, the present invention should be understood as broadly applicable to any hospitality facility in need of communicating with customers and facilitating communication between customers.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. An interactive customer computer system for a hospitality facility, comprising:
a Web client, the Web client presenting information to and accepting requests from the customer;
a property management system server, the property management system server comprising a customer database of the hospitality facility;
an event management server, the event management server providing convention scheduling information to the customer;
a facility services server, the facility services server providing the customer with the ability to request a hospitality service and to review information on the hospitality service; and
a Web server, the Web server connecting to the Web client, the property management system server, the event management server, and the facility services server, wherein the Web server associates the customer with a customer record from the customer database by matching data accepted from a request by the customer with a data element of the customer record.

2. The interactive customer computer system of claim 1, the customer comprising one or more of a hotel guest, a motel guest, a resort guest, a cruise ship guest, and a convention participant.

3. The interactive customer computer system of claim 1, the hospitality facility comprising one or more of a hotel, a motel, a resort, a cruise ship, and a convention center.

4. The interactive customer computer system of claim 1, the Web client comprising one of an in-room terminal and an in-room computer.

5. The interactive customer computer system of claim 1, the Web client comprising a computer kiosk within the hospitality facility that the customer accesses using an electronic room key card.

6. The interactive customer computer system of claim 1, the Web client presenting information to and accepting requests from the customer by one or more of reviewing account information, checking into the hospitality facility, checking out of the hospitality facility, requesting the hospitality facility service, reviewing the hospitality facility service, accessing a mapping system of the hospitality facility, accessing information about local attractions, reviewing messages, and reviewing a convention schedule.

7. The interactive customer computer system of claim 1, the hospitality service comprising one of room service, bell service, valet service, laundry service, housekeeping service, a spa appointment, and a business center appointment.

8. The interactive customer computer system of claim 1, the Web server sending targeted information sent to the Web client based on the customer record.

9. The interactive customer computer system of claim 1, the data element comprising a customer name, a customer identification number, a customer password, a customer room number, a customer email address, and a code from an electronic key card.

10. The interactive customer computer system of claim 1, further comprising a global network in communication with the Web server, the global network providing communication between the customer and an endpoint outside of the hospitality facility.

11. The interactive customer computer system of claim 1, further comprising a second Web client, the second Web client connected to the Web server and presenting information to and accepting requests from a second customer, the second Web client receiving a first message from the Web client and sending a second message to the Web client providing communication between the customer and the second customer within the hospitality facility.

12. The interactive customer computer system of claim 1, further comprising a second Web client, the second Web client connected to the Web server, the second Web client being accessed by a hospitality facility staff member and being used to send messages to customers based at least one of a group code, an affiliation code, and a rate plan code.

13. The interactive customer computer system of claim 1, further comprising an advertisement server, the advertisement server connecting to the Web server and providing a banner advertisement targeted to the customer.

14. The interactive customer computer system of claim 13, the banner advertisement being targeted based on criteria comprising at least one of a guest room, a convention participant name, a group code, an affiliation code, a rate plan code, a hospitality facility location, and a convention, the criteria being stored in the customer database.

15. The interactive customer computer system of claim 13, a click on the banner advertisement being recorded by the advertisement server.

16. The interactive customer computer system of claim 13, the advertisement server transmitting advertisements to more than one hospitality facility.

17. The interactive customer computer system of claim 1, further comprising a security server, the security server connecting to the Web server and providing at least one security service to the customer.

18. The interactive customer computer system of claim 17, the security service comprising one of authenticating an electronic key card, authenticating a magnetic key card, determining the last person to access a customer room, and determining if a customer room door is open.

19. The interactive customer computer system of claim 17, the security server being adapted to indicate whether a housekeeping staff member has entered a room in response to a query sent from the Web client.

20. The interactive customer computer system of claim 1, the Web server having a Web server database comprising information from one or more of the property management system server, advertisement server, the facility services server, and the event management server.

21. The interactive customer computer system of claim 20, the Web server database storing previous stay hospitality service information for the customer.

22. The interactive customer computer system of claim 21, the previous stay hospitality service information being accessed during a current stay of the customer.

23. A method for sending a group message from a hospitality facility administrator to a group of associated customers of a hospitality facility using a Web server of an interactive customer computer system of the hospitality facility, comprising:
displaying a group messaging Web page to the hospitality facility administrator;
receiving, from the hospitality facility administrator, a message comprising a code identifying the group of associated customers;
querying a customer database of the hospitality facility for customers who are associated with the code; and
sending the message to the customers.

24. The method of claim 23, the code comprising of an affiliation code, a group code, a rate plan code, and a code for all checked-in customers.

25. A method for sending a message from a first customer of a hospitality facility to a second customer of the hospitality facility using a Web server of an interactive customer computer system of the hospitality facility, comprising:
displaying a customer search Web page to the first customer;
receiving an identifier of the second customer from the first customer;
querying a customer database of the hospitality facility for customers associated with the identifier;
displaying the customers to the first customer;
receiving a selection from the customers from the first customer; wherein the selection comprises the second customer;
displaying a messaging Web page addressed to the second customer to the first customer;
receiving a message from the first customer; and
sending the message to the second customer.

26. The method of claim 25, the identifier comprising one of an entire last name, an entire last name and partial first name, and an entire last name and room number.

27. A method for targeting at least one banner advertisement to a group of associated customers of a hospitality facility using a Web server of an interactive customer computer system of the hospitality facility, comprising:
receiving an advertisement campaign from an advertisement server, wherein the advertisement campaign comprises the at least one banner advertisement and a code identifying a group of associated customers;
querying a customer database of the hospitality facility for customers associated with the code; and
displaying the at least one banner advertisement on a Web page sent to an associated customer.

28. The method of claim 27, the code comprising one of an affiliation code, a group code, a rate plan code, and a code for all checked-in customers.

29. The method of claim 27, furthering comprising recording if the customer clicks on the at least one banner advertisement.

30. The method of claim 29, further comprising reporting to the advertisement server a total number of clicks on the at least one banner advertisement performed by the customer and a room number of the customer.

31. The method of claim 27, furthering comprising recording a number of times the at least one banner advertisement is shown to the customer.

32. The method of claim 27, the advertisement campaign further comprising a hospitality facility location identifier.

33. The method of claim 27, the advertisement campaign further comprising a Web page location identifier.

34. The method of claim 32, furthering comprising displaying the at least one banner advertisement on the Web page if the Web page comprises the Web page location identifier.

35. A method for displaying to a customer directions from a customer room to a location within a hospitality facility using a Web server of an interactive customer computer system of the hospitality facility, comprising:
displaying a map service Web page to the customer;
receiving from the customer a map type for the location from the map service Web page and a Web client identifier;
querying a database of the Web server for a room corresponding to the Web client identifier; and
displaying to the customer a map depicting a route from the room to a nearest elevator and from the nearest elevator to the location.

36. The method of claim 35, the may type comprising one of child care, meeting rooms, restaurants, stores, pools, and local transportation.

37. The method of claim 35, the Web client identifier comprising an Internet protocol address.
